(19) United States
(12) Patent Application Publication
(10) Pub. No.: US 2007/0007188 A1
(43) Pub. Date: Jan. 11, 2007

(54) SYSTEMS AND METHODS FOR ORGANIC MATERIAL CONVERSION AND USE

(75) Inventors: Stefan Skrypski-Mantele, Schenkenzell (DE); Rodger W. Phillips, Vashon, WA (US); Josef Reichenberger, Warmensteinach (DE)

Correspondence Address: PRESTON GATES & ELLIS;ATTN: C. RACHAL WINGER, 925 FOURTH AVENUE, SUITE 2900, SEATTLE, WA, 98104-1158, US

(73) Assignee: WINTERBROOK INVESTMENT PARTNERS, LLC, Seattle, WA (US)

(21) Appl. No.: 11/427,475

(22) Filed: Jun. 29, 2006

Related U.S. Application Data
(63) Continuation-in-part of application No. 11/425,347, filed on Jun. 20, 2006.
(63) Continuation-in-part of application No. 11/379,404, filed on Apr. 20, 2006.
(60) Provisional application No. 60/692,099, filed on Jun. 20, 2005.
(60) Provisional application No. 60/675,511, filed on Apr. 27, 2005.
(60) Provisional application No. 60/695,608, filed on Jun. 30, 2005.

(51) Int. Cl. C02F 1/02

(52) U.S. Cl. 210/175

(57) ABSTRACT

Disclosed herein are systems and methods for thermal conversion of sludge into fuel and other products such as char. The systems and methods disclosed herein, among other benefits, convert sludge into fuel without the creation of reaction water and allow for the independent control of mixing and the movement of sludge through pyrolysis systems. Chars formed during pyrolysis have a number of beneficial uses.

### CROSS REFERENCES TO RELATED APPLICATIONS

The present application is a continuation-in-part of U.S. Patent Application Ser. No. 11/425,347 filed Jun. 20, 2006 (which claims the benefit under 35 U.S.C. §119 of U.S. Provisional Patent Application Ser. No. 60/692,099 filed Jun. 20, 2005) which is a continuation-in-part of U.S. patent application Ser. No. 11/379,404, filed Apr. 20, 2006 (which claims the benefit, under 35 U.S.C. §119 of 60/675,511, filed Apr. 27, 2005). The present application also claims the benefit under 35 U.S.C. §119 of U.S. Provisional Patent Application Ser. No. 60/695,608, filed Jun. 30, 2005. The contents of all these applications are incorporated herein in their entirety by reference.

### FIELD OF THE INVENTION

The present invention relates to the thermal conversion of sludge and other organic/carbonaceous materials into energy and other products.

### BACKGROUND OF THE INVENTION

Industrial and municipal wastewater treatment plants produce significant amounts of sludge, a material comprised of water, organic material (such as proteins, lipids and carbohydrates), and inorganic materials (such as clay and grit) that have not been eliminated during the treatment process. While most facilities have some form of onsite sludge treatment in order to reduce the volume and volatility of sludge, the final sludge product must ultimately be removed from the treatment plant for disposal.

In some cases, sludge is dewatered and dried to reduce the size and weight required for transport and disposal. In other cases, sludge is removed from the treatment plant in liquid form. In rare cases, facilities may utilize onsite incineration for final sludge disposal.

Because disposal at sea was banned several years ago, today's most common methods of final disposal for non-incinerated sludge have been land application and landfill. In land applications, sludge is sprayed or spread as a fertilizer on nonfood-crop agricultural fields. In landfill applications, sludge is simply buried, often alongside traditional municipal solid wastes.

All of the above sludge disposal scenarios contain significant environmental risks. For example, despite containing valuable plant nutrients such as phosphorus and nitrogen, sludge can also contain high levels of heavy metals and pathogens. The presence of these hazardous materials/substances and their potential concentration in agriculture fields over time, have made land application less desirable in recent years. Similarly these same contaminants can escape into groundwater near landfills and into the air via incinerator emissions. Given these issues, it is clear that there have historically been few environmentally safe methods for sludge disposal.

In recent years, new thermal processing technologies such as gasification and starved air incineration have emerged as viable sludge disposal options. These processes not only meet the primary goal of eliminating sludge, but they also do so in a way that converts much of the energy found in sludge into methane rich gasses. These gasses, in turn, can be used to create steam or heat for the generation of electrical power. Unfortunately, the gasses produced using these technologies are generally not condensable and have a relatively low energy content. They therefore cannot easily be stored and must be consumed as soon as they are created. This poses challenges when used for electrical generation because electricity demand falls at different points during a typical 24 hour period. During these low demand times, the gases cannot be used to provide additional electricity to the grid and must be flared to the atmosphere creating airborne pollution and generally wasting a valuable source of energy.

A more efficient form of sludge conversion involves the oxygen free thermal process known as pyrolysis. In pyrolysis, sludge material can be heated under high pressure or ambient pressure to form a gas that contains vaporized oils. Liquid oil can then be condensed from the gas in a process that is energy self-sufficient. In fact, the condensed oil is excess energy in a form that can be stored and transported for use at a later date. This process therefore provides at least two beneficial outcomes—economical sludge disposal and net energy generation in a form (e.g., liquid oil) that can be stored and transported as desired.

U.S. Pat. Nos. 4,618,735 and 4,781,796 describe a pyrolysis process and apparatus for the conversion of organic sludge into materials that may be useful as industrial fuels, including liquid oils. This process involves heating the sludge in an oxygen free environment to induce volatilization of the organic material contained therein, resulting in an energy rich gaseous byproduct and sludge residue. In another phase of the process, the gasses are further contacted with the residue at even higher temperatures to create oil producing reactions and gaseous products containing the oil products. The oil products are then condensed from the gasses in a separate phase of the process and may be stored and used as an industrial fuel. As described in these patents, char, the final solid form of sludge residue, is also removed from the process as a more easily disposed of material. The process described in these applications is known as a “single reactor” system.

In U.S. Pat. Nos. 5,847,248 and 5,865,956 a new process and apparatus that are based upon U.S. Pat. Nos. 4,618,735 and 4,781,796 are described. This updated process and apparatus incorporate a second reactor designed to improve the quality of the final oil through reductive, heterogenic, catalytic gas/solid phase reactions. This process and apparatus also include the addition of a new screw conveyor to remove char and solids from the second reactor, convey it through a cooling device, and ultimately discharge it from the process. The overall process described in these two patents is commonly referred to as a “dual reactor” system.

International Patent Application PCT/AU00/00206 (“the '206 application”) describes a simplified version of the process and apparatus described in U.S. Pat. Nos. 5,847,248 and 5,865,956 that could allow for more cost-effective operation. The updated design incorporated a catalytic converter to receive gasses from the first reactor. These gasses were subsequently condensed to produce reaction water and an oil product. Detailed descriptions of the catalytic converter temperatures and catalysts, and their effect on the formation or destruction of several gaseous compounds are outlined in the '206 application. This process and apparatus are commonly known as “catalytic converter” systems.

Finally, International Patent Application PCT/AU2003/001099 (“the '099 application”) describes a process and apparatus based upon the prior art described above. In this process and apparatus, features were incorporated to closely control the Solids Retention Time (SRT) and thus the resulting Weight Hour Space Velocity (WHSV)—a parameter directly related to the viscosity and overall quality of the final oil product.

In versions of the processes and apparatuses prior to the '099 application, sludge was positively conveyed through reaction zone(s) using screw conveyors. The speed of material conveyance, and thus the overall retention time of the solids in the reaction zone, was dependent upon the speed and pitch of these conveyors. However, for the best overall reaction producing the highest quantity and quality of oil, the sludge/char had to remain in the reaction zone for a relatively long period of time. This forced operators to operate the conveyors at very slow speeds. At such slow speeds, the heat and mass transfer within the reactor was compromised due to the lack of a mixing action from the slow moving screws. This design hindered the overall reaction, causing less than optimal oil viscosity.

In an attempt to address this problem, the '099 application described a process to allow for a more precise control of the inventory of char in the reactor and the WHSV. The application further provided data demonstrating the oil viscosity is closely tied to the WHSV regardless of sludge type or reactor configuration (ie., single or dual reactor).

The first feature described in the '099 application involved the replacement of screw conveyors with a series of pitched paddles affixed to a central rotating shaft in order to convey material through the reactor. By altering the number of paddles, the angle at which they address the sludge/char bed, and the speed at which they rotate, it was expected that operators could more easily control the amount of time material was held in the reaction zone. The paddles were also intended to provide proper mixing of char and vapor as well as enhanced heat transfer. With these factors under greater control, operators were expected to have much greater control over the WHSV.

A great deal of detail is provided in the '099 application regarding the position of paddles on the shaft, paddle shape, paddle angle, shaft rotational speed (RPM), paddle tip speed, and other parameters. These elements of the paddle conveyance system must all be calculated and designed prior to building the reactor, and many are not adjustable once the reactor is put into service. This is a major limitation of the '099 application. It is very difficult to predict precisely which combination of those factors will result in the best overall process prior to testing the apparatus. In fact, the prior approaches acknowledged the difficulty in keeping sludge from accumulating in certain areas of the reactor causing a torque overload on the rotating shaft and paddles.

Further, the '099 application described the overall reaction as occurring in two separate functional zones within the same reactor vessel in a single reactor system—a heating “zone” and a reaction “zone.” The heating zone provided a heating rate of 5-30° C./minute to induce volatilization and production of initial vapor and solid residue/char. The reaction zone was heated to a temperature of 400-450° C. to promote vapor-phase catalytic reactions through further mixing and increased collision of the vapors and solid residues. This is a limitation in that it is very difficult to create and distinguish a heating zone and a reaction zone in an open single reactor chamber.

Additionally, the '099 application described the use of an adjustable weir (or a fixed weir if the desired WHSV is known prior to manufacture) mechanism to control the inventory of char within the reactor. The adjustable weir was described as being rotated off center by approximately 30 degrees to conform to the position of the char bed caused by the paddle rotation, and was located immediately before the char outlet. No description was provided regarding the maximum or minimum height of the weir or its specific design. However, iterations of the adjustable weir in use at the time of the '099 application did not allow the reactor vessel to be filled to a level greater than a 30% coefficient of fill—thus limiting the overall inventory of solid material in the process.

Another problem in prior designs that remains to be addressed is the creation and disposal of reaction water during the gas condensation phase of the process. In known processes, vapors from the reactor are condensed using common water and oil-based direct spray condensers. Direct spray condensation chamber temperatures would routinely fall below 100° C. (for example, without limitation, to about 35° C.-45° C.), causing not only the oil in the vapor to condense but also any latent water vapor to condense into liquid water. A separate oil/water separation phase would then be required to separate clean oil from the reaction water. The reaction water would then return to the head works of the wastewater treatment plant where it could be combined with fresh influent and recycled through the entire wastewater treatment process.

A major limitation of this design is the quality of the water being returned to the treatment plant. Reaction water can be extremely high in nitrogen. Most treatment facilities can remove the relatively low levels of nitrogen found in typical municipal and industrial influent streams. When reaction water is added to the influent at the facility head works, however, the artificially high concentration of nitrogen can create substantial upsets in the overall treatment process leading to the discharge of sub-standard effluent water to local rivers and streams. Furthermore, if reaction water is not or cannot be returned to the head works, it must be stored onsite prior to other means of disposal. Storing the reaction water requires the capacity of a large wastewater treatment facility, which may not be obtainable or desirable for smaller operations. Further, because it is an extremely pungent material, the reaction water also requires storage in expensive leak-proof containers. Disposal of such water can also be costly and can release harmful gases into the air.

Another limitation of prior designs related to reaction water includes the requirement for a three-phase centrifugal separator to clean and separate the three constituents in the final condensed liquids (oil, particulate matter, and reaction water). If reaction water is eliminated from the process altogether, a much simpler two-phase centrifugal separator could be used. This advance would produce a key benefit because most centrifugal separators rely upon differences in material densities for proper separation. Many of the bio-oils produced in the prior processes, however, have very similar densities to the reaction water making separation difficult and time consuming.

A further limitation of prior approaches is related to the discharge of char from the reactor. In previous versions of pyrolysis processes and apparatuses, char was viewed as a waste product of the process and was passively transported from the end of the reactor (via gravity) through a vertical solid material outlet or “chute.” This outlet was sealed with a rotary valve mechanism designed to keep vapor from the reactor from escaping along with the char. Over time, however, it has become clear that there are two major drawbacks to a vertical chute and rotary valve design. First, the char material has a tendency to get stuck in the chute when there is no active process to push it through. A plugged outlet chute requires that the entire reactor be shut down and manually cleaned. Second, the rotary valves currently used have proven inherently leaky, allowing vapors from the reaction chamber to escape through the chute, out of the valve and into the surrounding atmosphere. These vapors, like the reaction water, have an extremely pungent odor, making operation of the unit uncomfortable for operators.

Based on the foregoing, there is room for improvement in pyrolysis systems and methods. The present invention provides numerous improvements addressing a number of described drawbacks inherent in prior approaches.

### SUMMARY OF THE INVENTION

The present invention provides improved pyrolysis systems and methods that address a number of described drawbacks associated with the prior art. The present invention also forms char with a variety of beneficial uses such that char need no longer be viewed as a waste product of pyrolysis processes.

As stated, one major drawback of the prior art is the production of reaction water due to the presently used condensation methods and resulting need for three-phase centrifugal separation of oil, particulate matter and reaction water. The present invention provides methods to avoid the production of reaction water, thus requiring only a two-phase centrifugal separation of oil and particulate matter and avoiding inefficiencies and environmental issues associated with reaction water. The present invention avoids the production of reaction water by condensing oils at a temperature above that at which water will condense. In one embodiment, this benefit is achieved by condensing oil with other oil cooled enough to condense additional oil but not cooled enough to condense water. This advance removes the numerous drawbacks associated with the production of reaction water that currently exist in presently used pyrolysis methods.

An additional drawback of the prior art is that conveyance of sludge through a reaction chamber occurred so slowly that the material was not mixed sufficiently during the process to allow sufficient contact between the sludge and vapors in the reaction chamber. International Patent Application PCT/AU2003/001099 (“the '099 application”) addressed this issue by moving sludge through a reaction chamber with paddles that mixed the sludge with its surrounding environment while simultaneously transporting it through the chamber. While this approach addressed the previous issue of insufficient mixing, it produced drawbacks of its own including the inability to independently control speed and amount of mixing with time of sludge in the reaction chamber and the need to calculate paddle parameters before the reactor was put into service (with an inability to readily adjust these parameters thereafter). Further with this approach, it was difficult to keep sludge from accumulating in certain areas of the reactor causing a torque overload on the rotating shaft and paddles. Thus, this process required that the entire system be shut down while manually actuated valves, screws, and other moving parts were adjusted and/or cleaned.

The present invention addresses these particular drawbacks by adopting mixing elements that can increase contact between sludge and vapors as the sludge moves through a reaction chamber (and becomes char) but do not convey the sludge/char material through the reaction chamber. By separating the function of conveying material through the reaction chamber and mixing the materials, various advantages are obtained including the advantage that operators can independently control time in the reaction chamber versus amount of mixing while in the chamber. This allows adjustment during sludge processing so that batch processing can be avoided. This approach also allows greater fill coefficients of the reaction chamber because, irregardless of the amount of mixing that occurs, the sludge and/or char can remain in the reactor chamber for any desired period of time. Thus, separating time spent in the chamber from the amount of mixing can increase contact between the shell and contents of the chamber to facilitate efficient heat transfer and production of quality bio-oil and/or chars. In one embodiment, adjustments can also occur through automated controls while the pyrolysis process remains on-going. The present invention also provides numerous other benefits over prior art approaches that will become clear through the entirety of the present disclosure.

The present invention also recognizes the numerous beneficial uses of char produced by pyrolysis processes. Accordingly, embodiments according to the present invention can include methods comprising (i) producing char using a pyrolysis process wherein the char is utilized for an industrial purpose or (ii) utilizing char produced through a pyrolysis process for an industrial purpose, wherein the pyrolysis process for both (i) and (ii) utilizes a system comprising a reactor module comprising a reaction chamber and a separation chamber; wherein in the reaction chamber sludge can be heated in an oxygen free state after which the sludge becomes vapor and char and wherein the separation chamber conveys the vapor and char out of the reactor module and wherein the system further comprises mixing elements within the reactor module that mix the sludge without substantially conveying the sludge through the reactor module.

In certain embodiments according to the present invention, the system further comprises an active sludge transport mechanism in the reactor module wherein the mixing elements and the active sludge transport mechanism can be independently controlled.

In certain embodiments according to the present invention, the char comprises a Brunauer, Emmett and Teller (BET) surface area of between about 400 m²/g and about 600 m²/g. In certain embodiments, the pyrolysis process can utilize waste heat. In another embodiment, during the pyrolysis process the char can be exposed to a temperature of at least about 550° C.

Industrial purposes according to the present invention can include, without limitation, the char being used as a pore generator in brick manufacturing, as a carbon black substitute, or both. In certain embodiments, before being utilized for an industrial purpose, the char can be converted to activated carbon. Activated carbon can be used for, without limitation, the absorption of metals; air purification; liquid purification, catalyst support; decolorization of beverages, sugar refining, deoderization, emergency poison treatment, solvent recovery and whiskey manufacturing.

Another embodiment according to the present invention includes a method of manufacturing bricks wherein the method comprises at least in part using char produced as the result of a pyrolysis process. In another embodiment, this method can comprise adding the char to raw materials used in brick manufacturing to form a mixture; drying the mixture to reduce moisture; and firing the mixture in a high temperature device wherein during the firing the char releases vapors creating stable micropores in the bricks thus improving the insulation properties of the manufactured bricks. In another embodiment, the drying step and/or the firing step can utilize waste heat. In another embodiment, the manufactured bricks comprise a heat transfer coefficient of less than about 0.27 W/m²/K.

### BRIEF DESCRIPTION OF THE DRAWINGS

FIG. 1 is a flow chart illustrating a process of conversion according to the present invention;

FIG. 2 is a cross-sectional illustration of a converter system formed according to the present invention;

FIGS. 3A-3C are enlarged views of an overflow weir, a control valve, and a char plug screw, respectively, in a reactor module according to the present invention;

FIG. 4 is an illustration of a condenser module according to the present invention; and

FIGS. 5A-5B are illustrations of a hot vapor combustion module according to the present invention.

### DEFINITION OF TERMS

To aid in understanding the following detailed description of the present invention, the terms and phrases used herein shall have the following, non-limiting, definitions.

As used herein, the term “sludge” includes any organic material that can be converted into an energy source at least in part or can be treated for disposal through the use of heat. In one embodiment, sludge includes sewage material from treatment plants, however the present invention is not so limited and can be used to treat any sort of organic material that can benefit in its conversion to energy, an energy source, an energy product, or a value-added product such as, without limitation, char.

As used herein, the term “oxygen free” means an atmosphere with an oxygen concentration that is too low to allow combustion or gasification of sludge.

As used herein, the term “purified” does not require absolute purity, rather, it is used as a relative term. Thus, a substance that is purified contains less contaminants after going through a process than it did before going through the process.

As used herein, the term “facility” includes any place, industrial or otherwise, that produces excess heat in a sufficient amount to contribute to the drying of sludge. Facilities include but are not limited to plants, factories and mills.

As used herein, the term “waste heat” includes heat generated from a process wherein the heat can be captured and directed. Thus, another appropriate term for the presently described waste heat could be “available heat.”

As used herein, the term “industrial purpose” includes a use to which char generated through a pyrolysis process can be put. While purpose is preceded by the modifier “industrial” the purpose is not so limited and can include any use to which the char can be put prior to its disposal (note that some uses can remove the necessity of disposing of the char altogether). Non-limiting examples of industrial purposes in accordance with the present invention include converting char into activated carbon for use in, without limitation, the absorption of metals; air purification; liquid purification, catalyst support; decolorization of beverages, sugar refining, deoderization, emergency poison treatment, solvent recovery and whiskey manufacturing; as well as for use as a pore generator (in one example in brick manufacturing) and as a carbon black substitute.

### DETAILED DESCRIPTION OF THE INVENTION

Industrial and municipal wastewater treatment plants produce significant amounts of sludge that must be properly treated for disposal. Thermal conversion processes such as pyrolysis can be used to convert sludge into bio-oil and char that can have a wide variety of commercial and industrial applications. However, prior approaches to these processes have suffered from many drawbacks. Some of these drawbacks include the creation of reaction water and the inability to independently control the mixing of sludge material within a reaction chamber and the time the sludge spends within the reaction chamber. This particular drawback requires that operation be conducted in batches whereby a batch of sludge material is fully processed before the quality of the resulting oil can be tested. This batch process is time consuming and, when adjustments are needed, requires that the entire pyrolysis process be shut down while manually actuated valves, screws, and other moving parts are adjusted. Previous approaches also encountered difficulties in obtaining quality char for industrial and/or commercial applications as well as in removing char from the reactor after processing. Based on these difficulties, char was viewed as a waste product of the pyrolysis process requiring disposal. The present invention addresses these and other drawbacks related to prior pyrolysis systems and methods and recognizes the commercial potentials of char produced by pyrolysis methods.

One aspect of the present invention provides pyrolysis systems and methods that do not produce reaction water. This advance is significant because the production of reaction water causes various inefficiencies and environmental problems as is understood by those of ordinary skill in the art. The present invention can prevent the production of reaction water by condensing bio-oils at a temperature above that at which water vapor condenses.

Other aspects according to the present invention allow operators to more precisely control the pyrolysis process, eliminating the need for batch processing, by making the speed through which sludge travels through a reactor module and the amount of mixing that occurs while therein independently controlled. The present invention allows for this independent control by separating the functions of moving sludge and mixing sludge to different system components. The present invention also allows more heat to be applied to material as it goes through the pyrolysis process. Additional heat (and longer exposure to the additional heat) creates a char that is more suitable for use as a precursor to activated carbon than chars created using previous pyrolysis methods. This benefit of the present invention is created by providing systems and methods that allow for a higher fill coefficient in the reactor chambers according to the present invention. A higher fill coefficient increases the available surface area for conductive heat transfer, thus allowing more heat to be applied and absorbed by the system. Other important features and advantages of the present invention will become apparent through the following detailed description.

I. Overview of Systems and Methods

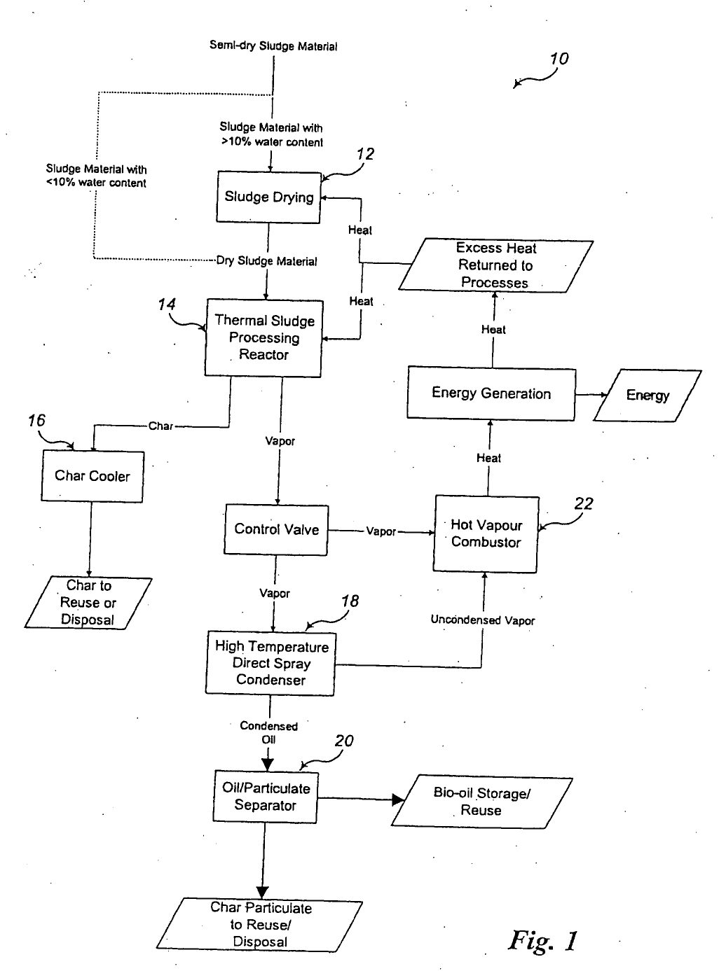

FIG. 1 depicts a flow chart of one method according to the present invention. In this depicted embodiment, sludge arrives at a system according to the present invention. If the arriving sludge has a water content of greater than about 20%, greater than about 10% or greater than about 5%, the sludge can enter a sludge drying module 12. If the sludge is below a pre-determined water content, the sludge can bypass sludge drying module 12. Once sludge has an acceptable water content, the sludge can enter a thermal reactor module 14. The reactor module 14 has a reaction chamber (also called a conversion zone herein) and a separation chamber. Within the reactor module 14, sludge is heated and processed to become char and vapors. Within the separation chamber, the vapors and char are separated. After leaving the separation chamber, char can enter a char cooler module 16 and can subsequently be safely disposed of or put to a number of beneficial commercial uses. After leaving the separation chamber, vapors are funneled through control valves directly to one or more of a condenser module 18 or a combuster module 22. If funneled to the condenser module 18, vapors are condensed to form oils. These oils can be purified in an oil/particulate separator module 20 following condensation after which removed particulate can be safely disposed of or put to other beneficial commercial uses. The oils collected following condensation and separation can be stored for use at a later time. Uncondensed vapors from the condenser module 18 as well as vapors directly from the control valve can also be funneled to a combuster module 22. This combuster module 22 combusts the vapors to generate energy. Generated energy can be diverted for uses such as the generation of electrical power or can be returned to the pyrolysis process as heat used in a drying module 12 or reaction module 14. The following description provides a more detailed explanation of embodiments according to the present invention.

II. Optional Drying

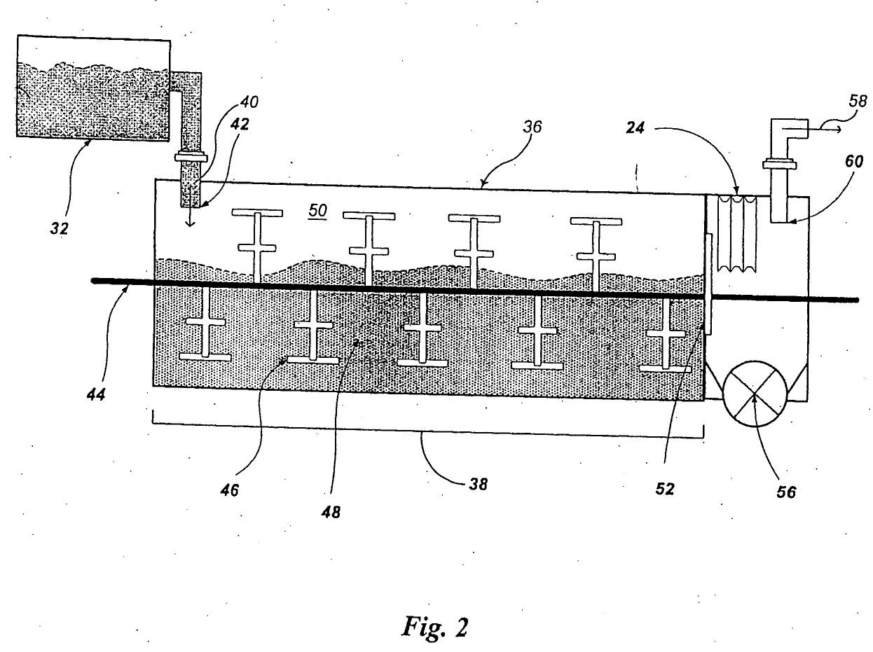

FIG. 1 depicts one beneficial embodiment according to the present invention. In this FIG. 1, the process 10 includes drying sludge in a dryer module (12 in FIG. 1; 32 in FIG. 2) before the sludge's entrance into the reactor module 14. Generally, when sludge does not arrive de-watered, it can be beneficial to dry it before processing. Drying sludge generally is beneficial because a higher water content means that more energy must be applied to a reaction chamber within the reactor module 14 to heat and volatilize the incoming material. As such, there can be great benefit in an integrated system that dries sludge to a low water content before it enters the thermal conversion process. In embodiments according to the present invention incorporating drying, sludge can be dried to a water content of less than about 20%, less than about 10%, or less than about 5% before entering the thermal conversion process. Dryers 12 (32) used in accordance with the present invention can be any appropriate form of commercial dryer including, without limitation, direct and indirect heated drum dryers as well as surface drum dryers. Drying can occur through, without limitation, centrifugation or heating provided by, for example, a source of existing waste heat or the combustion modules presently described. Drying mechanisms used in accordance with the present invention can also entail those described in co-pending U.S. patent application Ser. No. 11/379,404, filed Apr. 20, 2006, of co-pending U.S. patent application Ser. No. 11/425,347 filed Jun. 20, 2006 and of U.S. Provisional Patent Application Ser. No. 60/695,608, filed Jun. 30, 2005, the contents all of which are incorporated by reference in their entirety herein.

III. Reaction Chamber Comprising One Conversion Zone

Referring to FIG. 2, in accordance with the present invention, sludge 40 is heated in an oxygen free reaction chamber 36 of a reaction module to produce vapors and char. In one embodiment, the reaction chamber 36 can have a single heating/reaction zone for both heating the incoming material and thermally converting the material. When the reaction chambers of the present invention comprise a combined and continuous heating and reaction zone, this zone can be collectively referred to as a conversion zone 38. Sludge 40 can enter the reaction chamber 36 through a sealed material inlet 42 and can be immediately heated to a desired reaction temperature. In one embodiment, a rotating horizontal shaft 44 can extend the length of the reactor module (or a subset of this length) and can contain one or more mixing elements 46. The mixing elements 46 can rotate through the material bed 48 causing the material to be mixed and lifted into an upper portion 50 of the reaction chamber 36/conversion zone 38. Other methods of mixing and forms of mixing elements can also be adopted so long as the approach increases vapor and solid contact above that which would otherwise occur without such mixing. Mixing and contact can promote vapor-phase catalytic reactions and heterogenetic solid phase vapor phase catalytic reactions which, along with temperatures used in accordance with the present invention can help to ensure that carbohydrates are nearly completely converted to graphite with a high active surface area, classifying the char as an especially appropriate precursor for activated carbon manufacturing. Importantly, when mixing of the sludge occurs in accordance with the present invention, the rate of mixing and the rate of sludge movement through the reaction chamber 36/conversion zone 38 can be independently controlled. Thus, the material can be mixed in the reaction chamber 36/conversion zone 38 to promote vapor and char contact, but the mixing mechanism has little to no effect on material inventory and will not actively convey material through the reactor. This aspect of the present invention provides an important advance over previous pyrolysis methods allowing further control and adjustment of the pyrolysis process.

In one embodiment according to the present invention sludge is moved through the reactor module using gravity as a passive means to convey materials within the reactor module. In another embodiment sludge can be actively transported through the reactor module through a number of different mechanisms including, without limitation, a conveyor belt. Regardless of the transport mechanism used, these embodiments can further comprise an adjustable overflow weir 52 at the end of the reaction chamber 36/conversion zone 38 to control both the volume of material within the reaction chamber 36/conversion zone 38 and the rate of conveyance out of the reaction chamber 36/conversion zone 38. These adjustable overflow weirs 52 can include, without limitation, one or more gates. By controlling the volume of material in the reaction chamber 36/conversion zone 38 and its passage rate out of the reaction chamber 36/conversion zone 38, the weir 52 can allow variability in filling coefficients. Embodiments adopting active transport mechanisms allow for even more control than those adopting passive gravity control. In one specific embodiment, the filling coefficient is at least about 50%, which can allow for an efficient heat transfer from the shell of the reactor to the solids inside the reactor. Fill coefficients of at least about 50% can allow materials within the chamber to be heated to a higher temperature (for example, in one embodiment, to at least about 550° C.) than lower fill coefficients allow. These higher temperatures can allow for a more efficient and complete thermal conversion of sludge inside the reactor module and can produce higher quality chars for commercial and/or industrial applications. For instance, char exposed to these higher temperatures are especially suitable as precursors for activated carbon uses. Additionally, by controlling the rate of conveyance of material in a reactor module, the reactor module can maintain an appropriate WHSV for optimal vapors/bio-oil production.

Following heating, and in one embodiment mixing, in the reaction chamber 36/conversion zone 38 the produced vapors and char must be removed. Following removal, vapors can either be condensed to produce bio-oil, combusted to generate heat or to generate energy via one of many secondary heat-to-energy generation processes or both. Char can also be used in a variety of commercial endeavors. In one non-limiting example, the char is activated for filtering processes including, in one embodiment, mercury chelation. The removal and treatment of vapors is addressed first.

IV. Removal and Use of Vapors

Still referring to FIG. 2, vapors 58 are produced as sludge material passes through the reaction chamber 36/conversion zone 38. One limitation of prior approaches concerns the amount of particulate matter contained in the hot vapor as it exits the reaction chamber 36/conversion zone 38. In previous designs, the vapor outlet was unprotected and positioned in such a way as to allow vapor to be drawn directly from the main reactor chamber. This allowed char particles, disturbed by the mixing of mixing elements, to become airborne and exit the reaction chamber along with the vapor. This particulate matter created several problems in the rest of the process. First, the particulate matter had a tendency to clog valves in the oil condensation phase of the process requiring extensive filtering. Second, the filters routinely filled with particulate sludge and had to be cleaned, creating more disposal and odor issues.

The present invention addresses these issues by having the vapors 58 move through the conversion zone 38 toward a converter gas outlet 60. Prior to reaching the converter gas outlet 60, the vapors 58 can pass through a series of baffles 24 that can separate particulate matter from the vapors prior to their exit from the reaction chamber 36. These baffles 24, representing an improvement over prior approaches, can significantly reduce the amount of particulate matter such as char or dust near the gas outlet, which can reduce the amount of impurities in the resulting bio-oil.

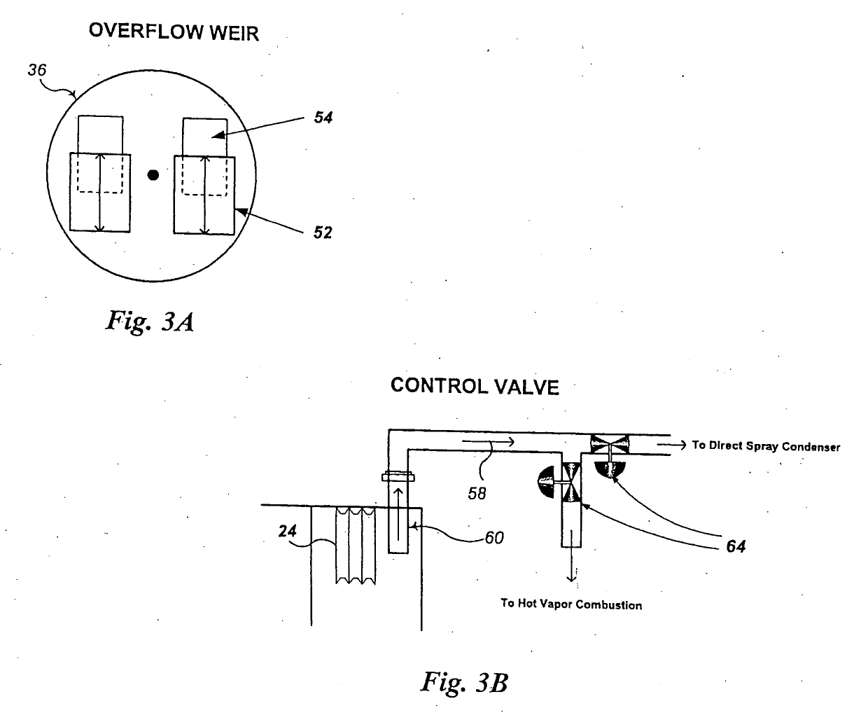

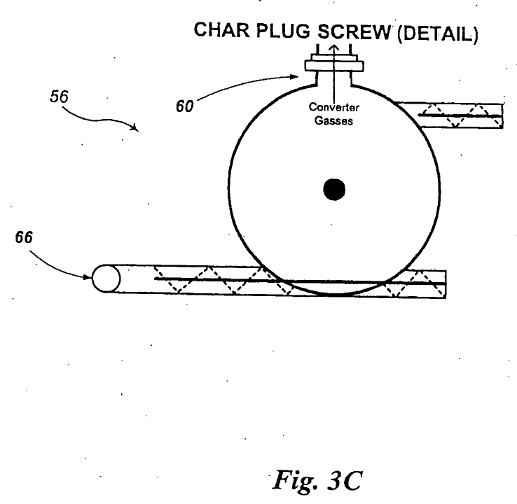

In another embodiment, after passing through the converter gas outlet 60, the vapors 58 can pass through one or more control valves (64 in FIG. 3B). These control valves 64 can be either automatically or manually actuated and can direct the flow of vapors to a direct spray condenser module, a hot vapor combustion module or both, depending upon the desired final product. If bio-oil is desired, the vapors 58 are directed to the direct spray condenser module. If immediate heat and/or energy are desired, the vapors 58 are directed to the hot vapor combustion module. When both are desired, vapors are directed to both a condenser module and a combustion module.

A. Condensor Module

When directed to a condenser module, the vapors are condensed at temperatures sufficient to avoid the condensation of free water found in the vapor thus preventing the production of reaction water. This aspect of the present invention represents one significant benefit of the systems and methods of the present invention. Free water can remain in vapor form and can be discharged from the condenser module along with other non-condensed vapors.

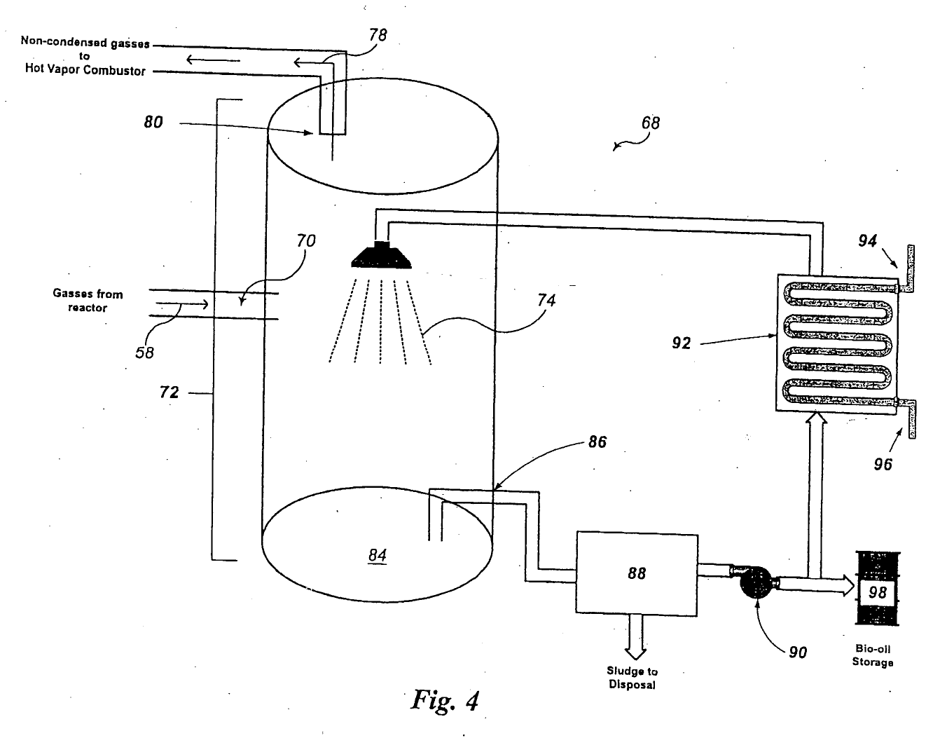

If directed to a direct spray condenser module, the vapors 58 can enter the Direct Spray Condenser module 68 as depicted in FIG. 4. The vapors 58 can be piped through an inlet opening 70 in the condensation chamber 72 where they can be immediately met with a direct spray of cooled bio-oil 74. The cooled bio-oil in turn can cool the vapors to a level that allows condensation of bio-oils out of the vapors. In one specific embodiment, the temperature in the condensation chamber 72 can remain at or above about 110° C., preventing water vapor from condensing into liquid water. In another specific embodiment, the temperature in the condensation chamber 72 can remain at about 100° C. In another specific embodiment, water vapor and uncondensed vapors 78 can exit the condensation chamber 72 via the outlet valve and piping 80 leading to a hot vapor combustion module.

In another embodiment, the bio-oil can be transferred via a pump 90 to a heat exchanger 92 designed to cool the bio-oil prior to re-introduction into the condensation chamber 72. The bio-oil can enter the heat exchanger 92 where it can be indirectly cooled by a source of incoming cooling water 94. The cooling water 94, which can be effluent from the wastewater process, can then be discharged from the heat exchanger 92 via a cooling water outlet 96. Because there can be no direct contact between the water and the bio-oil, further treatment of the water can be avoided. In another embodiment, the purified bio-oil can be pumped via pump 90 into storage barrels/tanks 98, where bio-oil can be stored for future use.

In another embodiment, condensed bio-oil (as well as a portion of the now re-heated bio-oil originally sprayed into the condensation chamber 72) can gather at the bottom 84 of the condensation chamber 72 where a U-Tube overflow device 86 can allow excess bio-oil to exit the condensation chamber 72. The excess bio-oil can then be directed to a centrifuge 88 for separation of particulate matter. In one specific embodiment, the centrifuge 88 can be a two-phase centrifugal separator that is configured to separate bio-oil and particulate. This is an advance over prior approaches requiring a three-phase centrifugal separator configured to separate bio-oil, particulate and water. In one specific embodiment, the purified bio-oil can be converted into oil-derived products, including without limitation diesel fuel, gasoline or heating oil.

B. Combustion Module

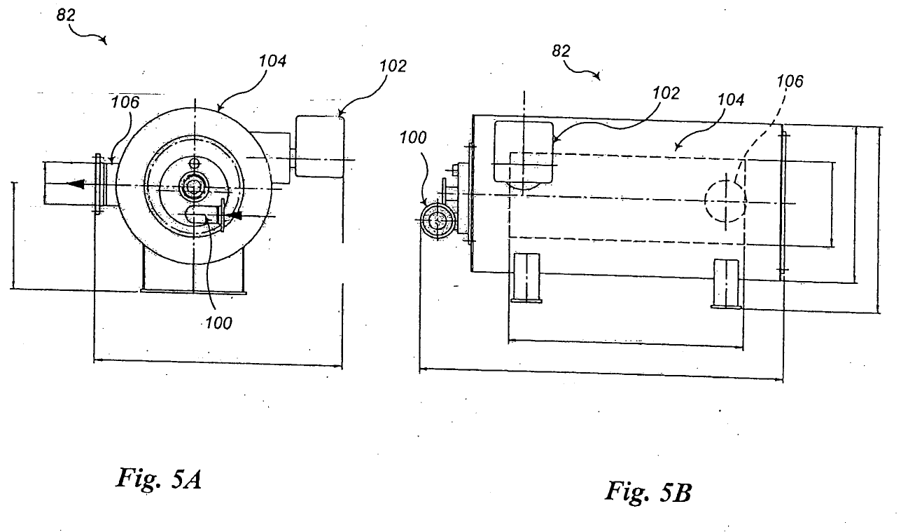

In one embodiment, the vapors can be directed to a hot vapor combustion (HVC) module 82 as shown in FIGS. 5A and 5B. The vapors can enter the module 82 through an inlet valve 100, which can precisely control the rate of process gas introduction into the HVC module 82. Water within the vapor can be combusted along with other non-condensed vapors in the HVC module portion of the process. Because such HVC devices are readily commercially available, the HVC module 82 will not be described in detail herein. Briefly, a burner 102 can provide heat to the combustion chamber 104, and a flue gas exit 106 can provide an outlet.

The HVC module 82 can be designed to meet regulatory requirements. For example, in Europe the only requirement the HVC module 82 has to meet is a minimal temperature of about 850° C. with a minimal gas residence time of two seconds. The reasoning behind this is that sewage sludge is classified waste within the European Union environmental jurisdiction and as a consequence of this any product from sludge is also classified as waste and subsequently has to meet waste incineration regulation. Past experience has shown that the minimal combustion chamber has to be about 650° C. to avoid the generation of soot. In the United States the combustion temperature and the gas residence time at the combustion temperature may be regulated completely differently, and as a consequence the dimensions of the HVC module 82 can vary. After the HVC module 82 an air pollution control device (APCD) (not shown) can be used to clean the emissions from the HVC to meet all applicable regulatory requirements.

One limitation of prior pyrolysis approaches concerns the lack of automated controls to monitor and control the process and apparatus for optimal oil production. Thus, previous designs relied upon “batch” operation whereby a batch of sludge material was fully processed before the quality of the resulting oil could be tested. The process was then manually adjusted when necessary to produce a higher quality end product. This iterative batch process was time consuming and required that the process be completely shut down while manually actuated valves, screws, and other moving parts are adjusted.

The present invention addresses this drawback of prior processes by providing for the control of the process through the use of advanced instrumentation and automated control systems. In one specific embodiment, the process can include an automatic control system to control the valving of vapors, which can enable precise control of the temperature inside the reactor. This can in turn control bio-oil production because bio-oil production can be more efficient and more manageable when run at lower temperatures such as 400-500° C. The control system can measure temperature in real time and manage the supply of vapors to the HVC, which can provide heat to the reactor module of the present invention.

V. Removal and Use of Char

Removal and use of char from the reaction chamber is also an important aspect of the present invention. Referring back to FIG. 2, in one embodiment, following the processing of sludge, char accumulates in the reaction chamber 36/conversion zone 38 until the material bed level rises above the level of the weir plate gates 52. Referring to FIG. 3A, when the material bed level rises above the level of the wier plate gates 52, gravity can convey the material through weir gate openings 54 and, in one embodiment, onto a char plug screw device (56 in FIG. 2) device. The adjustable weir plate gates 52 can control the depth of the material bed 48 and thus the overall volume of material in the conversion zone 38.

In one embodiment, the char can exit the reaction chamber in a manner designed to eliminate contact with outside air or accidental leaking of vapors. In one specific embodiment, the char at the end of the process can be removed by actively conveying the char from the downstream side of the weir to a char cooler. This can be accomplished by, without limitation, the use of a char plug screw. A char plug screw is an active device that can be used to convey char material from the reaction chamber 36/conversion zone 38 after it has passed through the adjustable weir gates. The char plug screw can provide an air tight seal to prevent hot vapors from leaking from the reaction chamber 36/conversion zone 38. In one specific embodiment as shown in FIG. 3C, the char plug screw 56 can actively convey the char material out of the bottom portion of reactor and onto a char cooling conveyor 66. The char plug screw 56 can convey char at different speeds, which can help eliminate clogging issues that are common in non-active char conveyor designs. This approach represents a significant advance over previously used methods that removed char from reaction chambers using gravity and chutes alone.

The disclosed embodiments according to the present invention also provide a char obtained from the thermal conversion of sludge. As stated, previous pyrolysis methods treated generated char as a waste product requiring disposal. Aspects according to the present invention recognize various beneficial uses of chars products by pyrolysis processes, including the chars produced by the systems and methods described herein. For example, chars can be processed to generate activated carbon. Activation can be carried out by, for example and without limitation, contact of the char with carbon dioxide or steam, as described in U.S. Pat. No. 6,537,947, which is incorporated by reference herein. There are many uses for this activated carbon including, without limitation, in the absorption of metals, such as mercury, in purification and/or chemical recovery operations as well as in environmental remediation. Other particular non-limiting examples of uses for activated carbon produced using chars generated from pyrolysis processes include in the application of air purification, catalyst support, decolorization in beverages and sugar refining, deoderization, metal recovery/removal, liquid purification, emergency poison treatment, solvent recovery, and/or whiskey manufacturing.

Chars made in accordance with the systems and methods of the present invention can be particularly useful in a variety of contexts due to the ability to achieve higher reaction temperatures due to higher filling coefficients, improved mixing and improved sealing of the reaction chamber among other features. These features of the present invention can alter the physical and/or chemical characteristics of the char, including, without limitation, its density, structure (geometric composition of carbon plates, etc.), Brunauer, Emmett and Teller (BET) surface area, number of active sites, and chemical compositions. Byway of example, and not as a limitation, the BET surface areas of the char produced by previous pyrolysis methods ranged from about 100-200 m²/g. The BET surface areas of the chars according to the present invention, in contrast, can range from about 400 to about 600 m²/g. This increase in BET surface area can make chars formed in accordance with the systems and methods described herein highly appropriate activated carbon precursors.

Chars can also be useful in brick manufacturing. In one embodiment, the char can have a relatively fine particle size and can be added to the raw materials used in brick manufacturing (for example and without limitation, natural clay minerals) to form a homogeneous mixture. Small amounts of manganese, barium, and other additives can also be added to the mixture to produce different shades and/or to improve the brick's chemical resistance to the elements. The mixture can be dried to remove excess moisture and then can be fired in high temperature furnaces or kilns according to methods known to those of ordinary skill in the art. During firing, the char can release vapors at high temperatures (in one embodiment at a temperature of about 550° C. or above) creating stable micropores in the bricks. These micropores can help reduce the thermal conductivity of the bricks improving their insulation properties. This use of chars can be especially useful in countries that have set standards to meet the CO₂-reduction goals set forth in the Kyoto protocol. For example, countries in Europe have introduced tighter standards with regard to heat transfer coefficients of construction materials. In Germany, new solid structure buildings must utilize building materials with a heat transfer coefficient of <0.27 W/m²/K. Chars can help achieve these goals by, without limitation, reducing the heat transfer coefficient of building materials either by generating micropores in building materials, being used as an insulation material, being used as a fuel reducing primary energy source or combinations thereof.

Chars can also be used as a carbon black substitute in a variety of manufacturing processes to reduce cost fluctuation. Carbon black is derived from the incomplete combustion of natural gas or petroleum oil and, as such, the cost of carbon black rises or falls with increases or decreases in oil and/or natural gas prices. The price of char on the other hand, can be independent from the prices of oil and/or natural gas, and can remain stable over a longer period time. These provided non-limiting examples help to illustrate the wide range of beneficial uses chars made during pyrolysis processes can have.

VI. Use of Waste Heat to Power Processes

Certain embodiments according to the present invention utilize waste heat. Waste heat can be produced by a number of different facilities, including, without limitation, power generation (coal-fired, natural gas fired, nuclear, etc.), wood product processing (pulp & lumber mills) and various other heat-producing manufacturing processes. The methods according to the present invention can include constructing one or more such facilities or processes in order to create a readily available source of waste heat for the downstream sludge drying, processing, and/or power generation processes, can use one or more already-existing sources of waste heat or both.

When waste heat is used, the systems and methods according to the present invention can include an apparatus to collect heat from the waste heat source in the form of, without limitation, heated air, steam, liquid, or another useable form. This apparatus can consist of heat exchangers installed in the exhaust stream from the heat source, where heat can be captured prior to other forms of disposal. As will be understood by one of skill in the art, the apparatus can include all necessary valves, ducts, fans, pumps, and piping to redirect the heated material.

The necessary valves, ducts, fans, pumps, and piping can control the delivery of waste heat to the downstream sludge drying and/or thermal processing stages using, in one embodiment, an automated control system. Using sensors located throughout one or more modules and processes, instantaneous heat requirements can be measured and the necessary valves, ducts, piping, fans and pumps can be affected to deliver the required heat from the waste heat source. Systems and methods to utilize waste heat in accordance with the systems and methods of the present invention are described more fully in U.S. patent application Ser. No. 11/379,404 which is fully incorporated by reference herein.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth herein are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Certain embodiments of this invention are described herein, including the best mode known to the inventors for carrying out the invention. Of course, variations of these embodiments will become apparent to those of ordinary skill in the art upon reading the foregoing description. The inventors expect skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, references have been made to patents and/or printed publications throughout this specification. Each of the above cited references and printed publications are herein individually incorporated by reference in their entirety.

In closing, it is to be understood that the embodiments of the invention disclosed herein are illustrative of the principles according to the present invention. Other modifications that may be employed are within the scope of the invention. Thus, by way of example, but not of limitation, alternative configurations according to the present invention may be utilized in accordance with the teachings herein. Accordingly, the present invention is not limited to that precisely as shown and described.

What is claimed is:

1. A method comprising:
producing char using a pyrolysis process wherein said char is utilized for an industrial purpose and wherein said pyrolysis process utilizes a system comprising a reactor module comprising a reaction chamber and a separation chamber; wherein in said reaction chamber sludge can be heated in an oxygen free state after which said sludge becomes vapor and char and wherein said separation chamber conveys said vapor and char out of said reactor module and wherein said system further comprises mixing elements within said reactor module that mix said sludge without substantially conveying said sludge through said reactor module.

2. A method according to claim 1 wherein said system further comprises an active sludge transport mechanism wherein said mixing elements and said active sludge transport mechanism can be independently controlled.

3. A method according to claim 1 wherein before being utilized for said industrial purpose, said char is converted to activated carbon.

4. A method according to claim 3 wherein said industrial purpose is selected from the group consisting of the absorption of metals; air purification; liquid purification, catalyst support; decolorization of beverages, sugar refining, deoderization, emergency poison treatment, solvent recovery and whiskey manufacturing.

5. A method according to claim 1 wherein said industrial purpose is selected from the group consisting of as a pore generator in brick manufacturing and as a carbon black substitute.

6. A method according to claim 1 wherein said char comprises a Brunauer, Emmett and Teller (BET) surface area of between about 400 m²/g and about 600 m²/g.

7. A method according to claim 1 wherein said pyrolysis process utilizes waste heat.

8. A method according to claim 1 wherein during said pyrolysis process said char was exposed to a temperature of at least about 550° C.

9. A method comprising:
utilizing char obtained from a pyrolysis process for an industrial purpose wherein said pyrolysis process utilizes a system comprising a reactor module comprising a reaction chamber and a separation chamber; wherein in said reaction chamber sludge can be heated in an oxygen free state after which said sludge becomes vapor and char and wherein said separation chamber conveys said vapor and char out of said reactor module and wherein said system further comprises mixing elements within said reactor module that mix said sludge without substantially conveying said sludge through said reactor module.

10. A method according to claim 9 wherein said system further comprises an active sludge transport mechanism wherein said mixing elements and said active sludge transport mechanism can be independently controlled.

11. A method according to claim 9 wherein before being put to said industrial purpose, said char is converted to activated carbon.

12. A method according to claim 11 wherein said industrial purpose is selected from the group consisting of the absorption of metals; air purification; liquid purification, catalyst support; decolorization of beverages, sugar refining, deoderization, emergency poison treatment, solvent recovery and whiskey manufacturing.

13. A method according to claim 9 wherein said industrial purpose is selected from the group consisting of as a pore generator in brick manufacturing and as a carbon black substitute.

14. A method according to claim 9 wherein said char comprises a Brunauer, Emmett and Teller (BET) surface area of between about 400 m²/g and about 600 m²/g.

15. A method according to claim 9 wherein said pyrolysis process utilizes waste heat.

16. A method according to claim 9 wherein during said pyrolysis process said char was exposed to a temperature of about 550° C.

17. A method of manufacturing bricks wherein said method comprises at least in part using char produced as the result of a pyrolysis process.

18. A method according to claim 17 wherein said method comprises adding said char to raw materials used in brick manufacturing to form a mixture;
drying said mixture to reduce moisture; and
firing said mixture in a high temperature device wherein during said firing said char releases vapors creating stable micropores in said bricks thus improving the insulation properties of said manufactured bricks.

19. A method according to claim 18 wherein said drying step and/or said firing step utilizes waste heat.

20. A method according to claim 17 wherein said manufactured bricks comprise a heat transfer coefficient of less than about 0.27 W/m²/K.
